(19) United States
(12) Patent Application Publication
(10) Pub. No.: US 2026/0225218 A1
(43) Pub. Date: Aug. 6, 2026

(54) LOAD-DEPENDENT DRIVE CONTROL OF A POWER TOOL

(71) Applicant: Hilti Aktiengesellschaft, Schaan (LI)

(72) Inventors: Maryam EFTEKHARI, Untermeitingen (DE); Markus SOMMER, Westendorf (DE)

(21) Appl. No.: 19/154,812

(22) PCT Filed: Feb. 13, 2024
(86) PCT No.: PCT/EP2024/053574

§ 371 Date: Aug. 8, 2025

(30) Foreign Application Priority Data
Feb. 27, 2023 (EP) 23158718.9

(51) Int. Cl. B25F 5/00

(52) U.S. Cl. CPC B25F 5/001

(57) ABSTRACT

A method and a corresponding drive arrangement for a load-dependent drive control of an electric power tool during at least one starting phase after switching on (I) an electric motor drive unit (5), comprising: starting (II) the speed-controlled electric motor drive unit (5) up to an initial start speed (V_{S}) below a nominal speed (V_{N}); monitoring (III) the motor reference current (I_{M}) of the electric motor drive unit (5) for exceeding a load limit value (I_{L}) representing the load of the electric power tool, and increasing (IV) the drive speed from the start speed (V_{S}) to nominal speed (V_{N}) if the actual motor reference current (I_{M}) exceeds the load limit (I_{L}).

The present invention relates to a method for load-dependent drive control of an electric power tool during at least one starting phase after an electric motor drive unit has been switched on. Furthermore, the invention relates to a speed-controlled drive unit for an electric power tool for carrying out this method and to an electric power tool as such. In addition, the invention also relates to a computer program or computer program product carrying out the said method.

The field of application of the invention extends primarily to hand-held power tools, such as in particular a rotary hammer, a demolition hammer but also e.g. an electric screwdriver. The electrical power supply can be cordless via an accumulator or corded in a conventional manner.

As the power-to-mass ratio of the power tools of interest here increases, the operation of the power tool becomes more difficult. This is because lower inertia leads to unsteady tool behavior, especially when a sudden load is applied. A sudden load occurs when the tool hits the workpiece with a high force. Therefore, a soft start functionality of the electric power tool is desirable.

### BACKGROUND

The document US 2018/0043521 A1 shows a hand-held electric power tool of the type of interest here, whose electric motor drive unit performs a soft start. For this purpose, a rotary motion sensor accommodated inside the handle of the machine housing detects a rotational movement of the machine housing about the working axis. The holding force is determined based on the amplitude of the rotary motion in the frequency range between 0.4 Hz and 4 Hz. If the determined rotational movement exceeds a limit value, the torque delivered by the electric power tool is reduced, to adapt the triggering behavior to the ascertained holding force of the user. The influence of the holding force on the mean motion of the hand-held power tool is not to be significantly differentiated from other influences on the mean motion. In particular, the various applications and associated different typical motions of one and the same power-held power tool make it difficult to identify the holding force. According to the present technical solution, it has been found that, in a narrow frequency range, the rotary motion about the working axis is significant for the holding force.

The document DE 10 2012 005 803 A1 describes another electric power tool in the form of a hammer drill with a load-dependent adjustment of the number of strokes. Here, a force detection device can detect the pressing force of the operator on the handle of the machine housing. If the detected pressing force exceeds a predetermined working impact force limit, the impact frequency of the impact mechanism can be increased to a predetermined working frequency. If the operator's detected pressing force falls below a predetermined idle impact force limit, the impact frequency can be decreased to a predetermined idle frequency. This ensures that the tool cannot jump away due to excessive impact force when applied to a workpiece to be machined.

The document EP 2 324 961 B1 discloses another hand-held power tool which performs a predetermined operation with a tool bit detachably mounted in a front-end region of a tool body against a workpiece, comprising a plurality of detecting sensors of different kinds which detects several load conditions different in presence or absence and magnitude of load applied to the tool bit. An indicating device indicates the load conditions based on a result detected by the detecting sensors and a driving control device control driving of the tool bit based on a result detected by the detecting sensors for the same purpose as described above.

### SUMMARY OF THE INVENTION

All the technical solutions discussed above for load-dependent drive control of an electric power tool require additional sensors and accessories to determine the current load state. Furthermore, the signals measured by the sensor elements must be analyzed and interpreted by additional signal processing means to generate suitable control commands for the electric motor drive unit.

It is an object of the present invention to further improve a method as well as an arrangement for load-dependent drive control of a power tool in such a way that improved powering of the electric power tool, in particular during the starting phase after switching on the electric motor drive unit, is improved with less technical effort.

The present invention provides a method for a load-dependent drive control of an electric power tool during at least one starting phase after switching on (I) an electric motor drive unit (5), comprising the following steps: starting (II) the speed-controlled electric motor drive unit (5) up to an initial start speed (V_{S}) below a nominal speed (V_{N}), monitoring (III) the motor reference current (I_{M}) of the electric motor drive unit (5) for exceeding a load limit value (I_{L}) representing the load of the electric power tool, increasing (IV) the drive speed from the start speed (V_{S}) to nominal speed (V_{N}) if the actual motor reference current (I_{M}) exceeds the load limit (I_{L}). A speed-controlled drive arrangement suitable for carrying out the method, an electric power tool with such a speed-controlled drive arrangement, and a computer program product for carrying out the method according to the invention, the steps of which are implemented in corresponding program code, are also provided.

The invention includes the technical teaching that during at least the starting phase after switching on the electric motor drive unit, which is operated in a speed-controlled manner, the latter starts up to an initial starting speed V_{S} below a nominal speed V_{N}. Subsequently, the motor reference current I_{M} of the electric motor drive unit is monitored for exceeding a load limit value I_{L} representing the load of the electric power tool. If the current motor reference current I_{M} exceeds the load limit value I_{L}, the drive speed is increased from the starting speed V_{S} to nominal speed V_{N}. Otherwise, the starting speed V_{S} is maintained.

The solution according to the present invention is based on the knowledge that the motor reference current I_{M} of the electric motor drive unit is functionally related, for example proportionally, to the load on the electric power tool. If, for example, the load on the electric power tool increases as a result of the tool being pressed against the workpiece to be machined, this can be read off from a correspondingly increasing motor reference current I_{M}. Since the output power of the electric power tool is approximately proportional to the motor speed, the solution according to the present invention controls the tool speed in order to improve the handling of the electric power tool by changing the drive speed. This is done by the load-dependent drive control of the drive speed according to the present invention via a detection of the motor reference current. Additional sensor elements and the signal processing required for this are not needed. The solution according to the present invention relies exclusively on parameters already available within the scope of a speed control of the drive unit to set the desired drive speed, which enables a soft start of the electric power tool for improved handling. It also depends on the threshold level of motor reference current I_{M} for detection of applying or removing load.

Preferably, the reduced starting speed V_{S} is maintained until the motor reference current I_{M} exceeds the load limit value I_{L} at least once. It is possible to return to the starting speed V_{S} when the load decreases again, caused for example by the workpiece being set down from the tool.

According to a preferred embodiment of the invention, the initial starting speed V_{S} is set to 70% of the nominal speed V_{N}, whereby a tolerance range of preferably +/−25% is permissible. In order to enable a particularly effective soft start phase, a tolerance range of +/−10% is optimal in order to ensure a sufficient initial power of the electric power tool, which is not too high to significantly worsen the handling when placing the tool on the workpiece.

Preferably, the load limit value I_{L} representing the load corresponds to at least 60% of the full load of the electric power tool. This means that from this limit value, the switchover is made to the full nominal speed V_{N} to enable a sufficiently soft start phase.

For the same reasons, it is additionally proposed that the speed-controlled increase of the drive speed from the starting speed V_{S} to nominal speed V_{N} is carried out with a gradient of maximum 0.8. This allows a gradual increase to the higher nominal speed V_{N} and thus prevents a too sudden jump in speed from occurring. Of course, the gradient also depends on the system inertia, so that an increase carried out by the speed control can also be omitted if necessary in the case of particularly high rotating masses.

The method according to the invention described above can be carried out with a speed-controlled drive device for an electric power tool, which comprises an electric motor drive unit accommodated in a machine housing, which can be switched on by an operator from an electric switch arranged on the machine housing. An electromotive control unit provides for starting the electromotive drive unit up to the initial starting speed V_{S}, which is below the nominal speed V_{N}. A comparison unit is provided for monitoring the motor reference current I_{M} of the electromotive drive unit for exceeding a stored load limit value I_{L} representing the load of the electric power tool. If the current motor reference current I_{M} exceeds the load limit value I_{L}, the control unit increases the drive speed to nominal speed V_{N}, thereby providing the full power of the electric power tool.

Preferably, at least the load limit value I_{L} used for the described comparison purposes is stored in an electronic memory unit. The load limit value I_{L} is machine-specific and is stored at least once in the memory unit. Also, the parameter start speed V_{S} is preferably stored in the same or another memory unit.

According to a preferred embodiment of the electromotive drive unit, it is designed as a brushless DC motor (BLDC), which is operated by the electronic speed control device as described above.

Furthermore, it should be noted that the method according to the present invention for implementation in the electronic speed-controlled drive device described above is designed as a software program with suitable program code.

### BRIED DESCRIPTION OF THE DRAWINGS

Further technical features improving the invention are shown in more detail below together with a description of a preferred embodiment of the invention with reference to the figures.

FIG. 1 shows a schematic side view of an electric power tool with speed-controlled drive means implemented herein,

FIG. 2 shows a block diagram of the drive means according to FIG. 1,

FIG. 3 shows a schematic flow chart illustrating the process steps, and

FIG. 4 shows a graphical representation of the speed control during the start phase of the electric motor drive unit.

### DETAILED DESCRIPTION

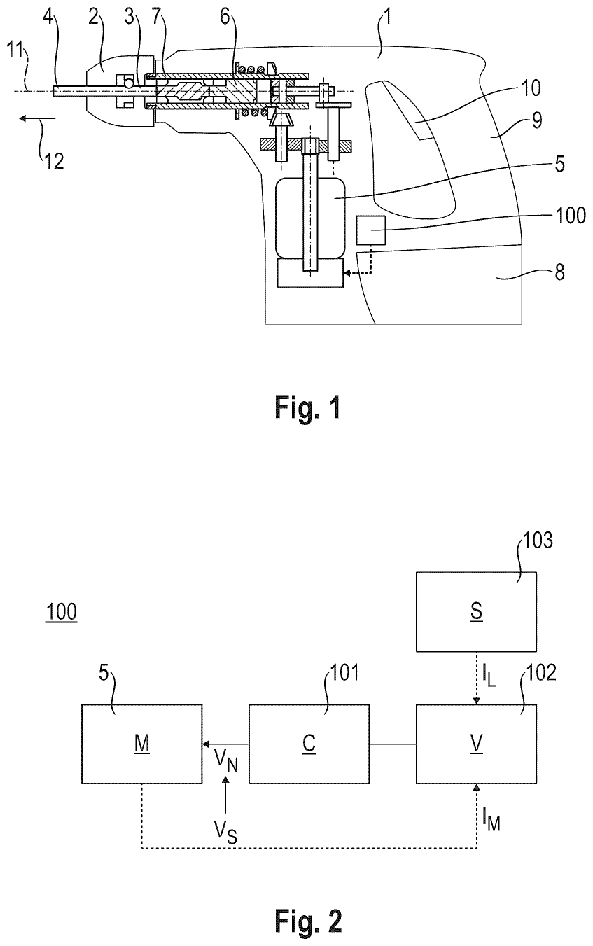

FIG. 1 shows a hammer drill as an exemplary embodiment of a hand-held power tool, which comprises a machine housing 1 for accommodating the drive means. The power tool further comprises a tool holder 2, into which a shaft end 3 of a tool, e.g. of drill bit 4, may be inserted. An electric motor drive unit 5, which drives a hammer mechanism 6 and an output shaft 7, form one primary drive of the power tool. In this embodiment, the electric motor drive unit 5 is designed as a brushless DC motor. A battery pack 8 supplies the electrical drive unit 5 with electrical current. A user may guide the power tool with the aid of a handle 9 and may start the power tool with the aid of an electrical switch 10.

During operation, the power tool rotates drill bit 4 about a working axis 11 and may thereby hammer drill bit 4 into a workpiece in direction of impact 12 along the working axis 11. For controlling the electric motor drive unit 5, the electric power tool also comprises an electronic device 100.

According to FIG. 2, the electronic device 100 comprises an electronic control unit 101 for speed control of the connected electric motor drive unit 5. After switching on the electric motor drive unit 5, the electronic control unit 101 initially causes the electric motor drive unit 5 to start up to an initial starting speed V_{S} below the nominal speed V_{N}, which is approximately 70% of the nominal speed V_{N}.

A comparison unit 102 connected to the electronic control unit 101 provides a reference value to the electronic control unit 101. The comparison unit 102 monitors the motor reference current I_{M} of the electric motor drive unit 5 and compares it with a load limit value I_{L} stored in a memory unit 103. If the actual motor reference current I_{M} exceeds the load limit value I_{L}, the drive speed is increased from the starting speed V_{S} to the full rated speed V_{N} by the control unit 101 by means of an amended setpoint.

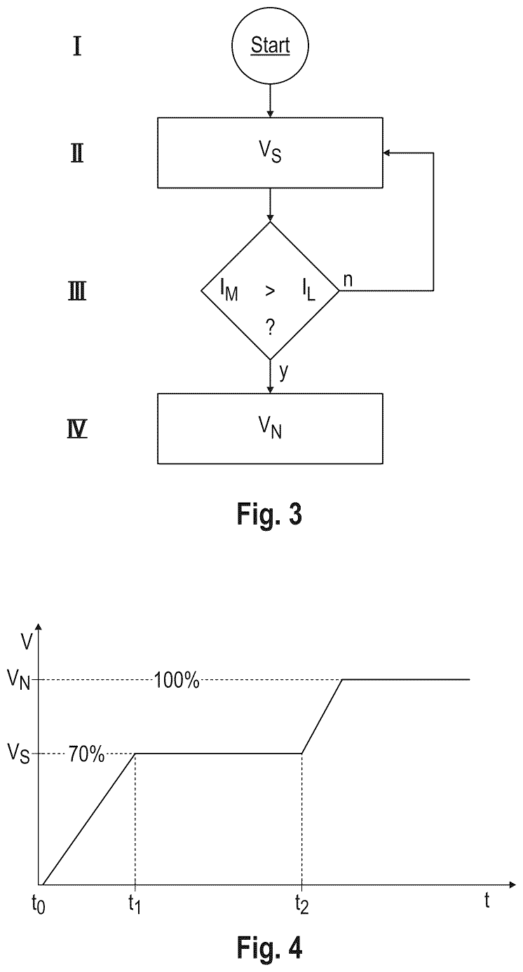

In view of FIG. 3, the method according to the invention for a load-dependent drive control of a power tool described above comprises the following steps during at least the initial soft start phase:

After the electric motor drive unit has been switched on (I), the electric motor drive unit 5 is started up (II) to an initial start speed V_{S} below a nominal speed V_{N}. Subsequently, the motor reference current I_{M} of the electric motor drive unit is monitored (III) for exceeding a load limit value I_{L} representing the load of the electric power tool. If the electrical motor reference current I_{M} exceeds the load limit value I_{L}, the next step is to increase the drive speed from the starting speed V_{S} to the higher nominal speed V_{N}. Otherwise, the electric motor drive unit continues to be operated at starting speed V_{S}.

FIG. 4 illustrates an exemplary speed control time line as described above. At a start time to, the electric motor drive unit starts up to 70% of the nominal speed V_{N} to the first point in time t₁. This corresponds to the starting speed V_{S}. This starting speed V_{S} is maintained until, on the basis of the monitoring of the motor reference current described above, a sufficient load on the electric power tool has been detected to increase the drive speed from the starting speed V_{S} to full nominal speed V_{N} at the second point in time t₂. This characteristic is provided at least for the starting phase of the electric power tool.

The invention is not limited to the preferred embodiment as described above. Variations thereof are also conceivable, which are included in the scope of protection of the following claims. For example, it is also possible to repeat the load-dependent drive control procedure according to the invention even after the tool has been set down from the workpiece. In this case, the electrical motor drive unit would fall back to the starting speed V_{S} before the load on the electric power tool is repeated after the tool is set down on the workpiece again.

### REFERENCE SIGNS

1 machine housing
2 tool holder
3 shaft end
4 drill bit
5 electric motor drive unit
6 hammer mechanism
7 output shaft
8 battery pack
9 powerle
10 electrical switch
11 working axis
12 impact
100 electronical device
101 control unit
102 comparison unit
103 memory unit
V_{N} nominal speed
V_{S} start speed
I_{M} motor reference current
I_{L} load limit current
t0 start time
t1 first point in time
t2 second point in time

What is claimed is:

1-9. (canceled)

10: A method for a load-dependent drive control of an electric power tool during at least one starting phase after switching on an electric motor drive unit, the method comprising the following steps:
starting the speed-controlled electric motor drive unit up to an initial start speed below a nominal speed;
monitoring a motor reference current of the electric motor drive unit for exceeding a load limit value representing a load of the electric power tool; and
increasing the drive speed from the start speed to the nominal speed when the monitored motor reference current exceeds the load limit.

11: The method as recited in claim 11 wherein the start speed is maintained until the motor reference current exceeds the load limit at least once.

12: The method as recited in claim 11 wherein the initial start speed is set to 70% of the nominal speed with a tolerance range of +/−25%.

13: The method as recited in claim 11 wherein the initial start speed is set to 70% of the nominal speed with a tolerance range of +/−10%.

14: The method as recited in claim 11 wherein the load limit value representing the load corresponds to at least 60% of the full load of the electric power tool.

15: A drive arrangement for an electric power tool for carrying out the method as recited in claim 11, the drive arrangement comprising:
a machine housing accommodating the electric motor drive unit, the electric drive unit switchable on by an electrical switch arranged on the machine housing;
an electronic control unit configured to start up the electromotive drive unit to the initial starting speed; and
a comparison unit configured to monitor the motor reference current of the electric motor drive unit, wherein the electronic control unit increases the drive speed to the nominal speed when the current motor reference current exceeds the load limit value.

16: The drive arrangement as recited in claim 15 further comprising a memory unit connected to the comparison unit and for storing the load limit value.

17: The drive arrangement as recited in claim 15 wherein the electric motor drive unit is designed as a brushless DC motor.

18: An electric power tool comprising the drive arrangement as recited in claim 15.

19: A computer program comprising commands which, when the program is executed by a computer, cause the computer to perform the steps of the method as recited in claim 11.
